(19) United States
(12) Patent Application Publication
(10) Pub. No.: US 2026/0088693 A1
(43) Pub. Date: Mar. 26, 2026

(54) VIBRATION ENERGY HARVESTING SYSTEM

(71) Applicant: Toyota Motor Engineering & Manufacturing North America, Inc., Plano, TX (US)

(72) Inventors: Taehwa Lee, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/895,612

(22) Filed: Sep. 25, 2024

(51) Int. Cl. H02K 35/00

(52) U.S. Cl. CPC H02K 35/00

(57) ABSTRACT

Vibration energy harvesting systems are described herein. In one example, a system includes a first structure having a coil, a second structure having a magnet, and a coupling structure connecting the first structure to the second structure.

### TECHNICAL FIELD

The subject matter described herein relates, in general, to vibration energy harvesting systems.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Vibration energy harvesting systems convert mechanical vibrations into electricity. Electromagnetic vibration harvesting systems, in particular, use Faraday's law of induction to convert the kinetic energy of the vibrations into electrical energy. These systems typically include a magnet and a coil, wherein one of these elements is in a fixed position and the other element can move relative to this fixed position. When this movement happens, a change in magnetic flux occurs, resulting in an electromagnetic force being produced.

### SUMMARY

This section generally summarizes the disclosure and is not a comprehensive explanation of its full scope or all its features.

In one embodiment, a system includes a first structure having a coil, a second structure having a magnet, and a coupling structure connecting the first structure to the second structure.

In another embodiment, a vibration energy harvesting system includes a first cantilever extending from a surface and terminating with a distal end having a coil coupled thereto, a second cantilever extending from the surface and terminating with a distal end having a magnet coupled thereto, and a coupling structure connecting the first cantilever to the second cantilever. The magnet and coil are positioned such that when the coil and magnet move with respect to each other, a voltage is produced at the coil.

In another embodiment, a system includes a first cantilever having a coil, a second cantilever having a magnet, and a coupling structure connecting the first cantilever to the second cantilever. Like before, the magnet and coil are positioned such that when the coil and magnet move with respect to each other, a voltage is produced at the coil.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one example of a vibration energy harvesting system that utilizes coupled resonance.

FIG. 2 illustrates the vibration energy harvesting system of FIG. 1 modeled as coupled harmonic oscillators.

FIG. 3 illustrates one example of an energy storage device that may be utilized with the vibration energy harvesting system of FIG. 1.

FIG. 4 illustrates a spectral response of the vibration energy harvesting system of FIG. 1.

FIG. 5 illustrates a relative displacement of the magnet and coil of the vibration energy harvesting system of FIG. 1.

### DETAILED DESCRIPTION

The vibration energy harvesting systems described herein use coupled resonance to improve performance. Moreover, in one example, a vibration energy harvesting system includes two cantilevers extending from a surface. One of the cantilevers has a magnet coupled to it, while the other cantilever has a coil coupled to it. In addition, to take advantage of coupled resonance, a coupling structure connects the cantilevers to each other. As will be explained later in this description, the vibration harvesting systems described herein outperform prior art solutions that do not utilize coupled resonance.

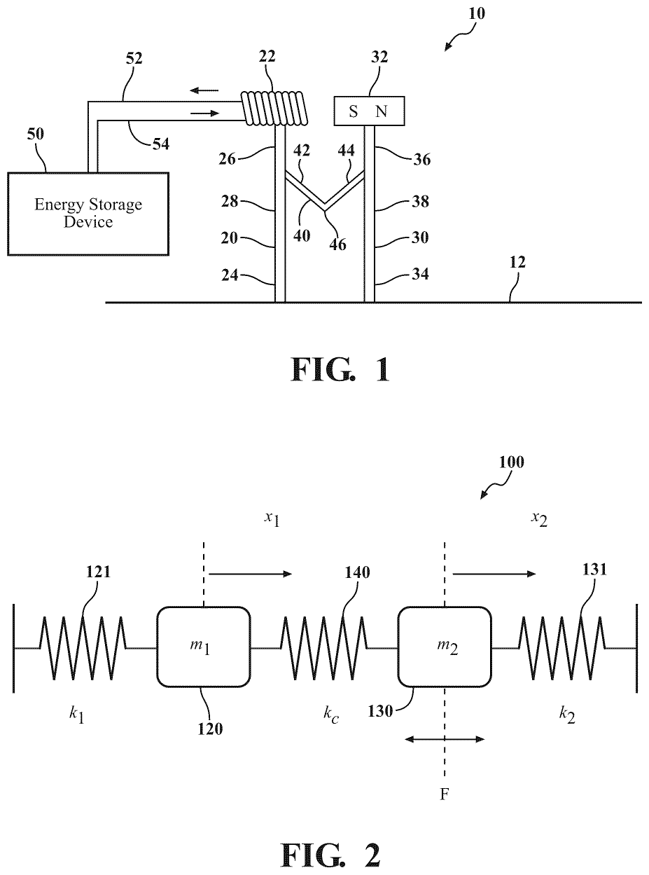

Referring to FIG. 1, illustrated is one example of a vibration energy harvesting system 10 that utilizes coupled resonance. Moreover, the vibration energy harvesting system 10 includes a structure 20 and a structure 30 that may be connected to and extend from a surface 12. In this example, the structure 20 and the structure 30 are both cantilevers that generally extend in a direction perpendicular to the surface 12. As such, the structures 20 and 30 can be formed as beams, plates, trusses, slabs, and the like. Further still, it should be understood that the structure 20 and the structure 30 may take any one of a number of different forms and should not be limited to just cantilevers. In one nonlimiting further example, instead of being cantilevers, the structures 20 and 30 could be membranes that are able to resonate.

The structures 20 and 30 can be made out of a number of different materials that allow the structures 20 and 30 to resonate and move with respect to one another. In some cases, the structures 20 and 30 may be identical to each other and/or be made of the same material. In one example, the structures 20 and 30 may have substantially similar dimensions and have substantially similar properties, such as substantially similar stiffnesses.

The structure 30 may have a base end 34 that is located adjacent to the surface 12 and a distal end 36 located on the opposite end of the structure 30. A middle portion 38 may be located between the base end 34 and the distal end 36. Attached to the distal end 36 of the structure 30 may be a magnet 32. While the magnet 32 is shown attached to the distal end 36 of the structure 30, it should be understood that the magnet 32 may be attached anywhere along the structure 30 based on the application and the performance sought. For example, the magnet 32 may be located closer to the base end 34 and/or the middle portion 38 of the structure 30.

The magnet 32 can take any one of a number of different forms and be made of any one of a number of different materials. For example, the magnet 32 may be a neodymium iron boron (NdFeB) magnet, a samarium cobalt (SmCo) magnet, an alnico magnet (composed of aluminum, nickel, and cobalt, a ceramic (ferrite) magnet, and the like.

Similar to the structure 30, the structure 20 may have a base end 24 that is located adjacent to the surface 12 and a distal end 26 located on the opposite end of the structure 20. A middle portion 28 may be located between the base end 24 and the distal end 26. Attached to the distal end 26 of the structure 20 may be a coil 22. In this example, the coil 22 is an electromagnetic coil, which may be made of wound copper or other appropriate material, that generates electricity once the coil 22 and/or magnet 32 move relative to each other. As will be explained later, this movement effectively converts mechanical energy into electrical energy, which is stored in an energy storage device 50.

In order to take advantage of coupled resonance, the vibration energy harvesting system 10 also includes a coupling structure 40 that mechanically connects the structure 20 to the structure 30. The coupling structure 40 can take any one of a number of forms so long as it mechanically connects the structure 20 to the structure 30. For example, the coupling structure 40 may be in the form of a spring that couples the structures 20 and 30 to each other. Here, the coupling structure 40 includes members 42 and 44 that connect to the structures 20 and 30, respectively. The members 42 and 44 connect at a connection point 46. Of course, as mentioned before, it should be understood that this is just one example of the coupling structure 40 and that the coupling structure 40 can take any one of a number of different forms.

In this example, the coupling structure 40 is connected to the middle portion 28 of the structure 20 and the middle portion 38 of the structure 30. However, it should be understood that the coupling structure 40 can be connected to any portion of the structures 20 and 30 and is not merely limited to the middle portions 28 and 38. The coupling structure 40 can be made of any suitable material. In some cases, the coupling structure 40 may be made of the same material as the structures 20 and/or 30 but could also be made from different materials as well. In one example, the stiffness of the coupling structure 40 may be less than the stiffnesses of the structures 20 and/or 30.

The coupling structure 40 essentially allows the vibration energy harvesting system 10 to take advantage of coupled resonance. Moreover, since the structures 20 and 30 are connected using the coupling structure 40, the vibrational energy of the structures 20 and 30 influences the other, leading to a shared resonant frequency. When the structures 20 and 30 are mechanically connected, their resonant frequencies interact, creating a system where energy can transfer between them. This coupling can result in complex vibrational modes where the structures 20 and 30 oscillate in phase or out of phase with each other. The interaction enhances the overall energy harvesting efficiency by broadening the frequency range over which the vibration energy harvesting system 10 can effectively operate.

To better understand the coupled resonance of the structures 20 and 30, reference is made to FIG. 2, which illustrates a model 100 of the vibration energy harvesting system 10 modeled as coupled harmonic oscillators. In the model 100, the mass 120 (m₁) represents the mass of the coil 22 and the mass 130 (m₂) represents the magnet 32. The spring 121 (k₁) represents the stiffness of the structure 20, the spring 131 (k₂) represents the stiffness of the structure 30, and the spring 140 (k_{c}) represents the stiffness of the coupling structure 40. The relative displacements (x₁ and x₂) of the mass 120 and the mass 130, respectively, can be maximized at resonance, leading to efficient energy harvesting when a force F is experienced by the vibration energy harvesting system 10. The performance of the vibration energy harvesting system 10 will be described later in this description.

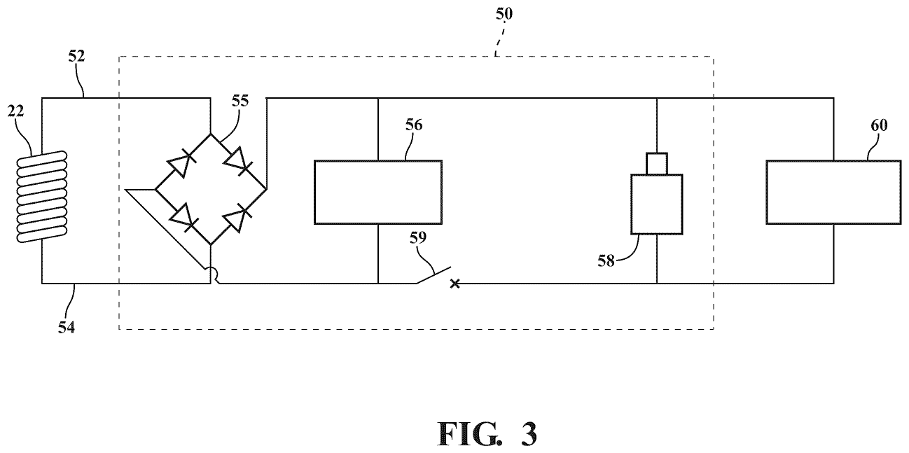

FIG. 3 illustrates a more detailed view of the energy storage device 50. It should be understood that the energy storage device 50 can take any one of a number of different forms and that this is just one example of the energy storage device 50. Here, as mentioned before, the coil 22 generates a current when the coil 22 and the magnet 32 move with respect to each other. The energy storage device 50 may be connected to the coil 22 via electrical conduits 52 and 54. Moreover, electrical conduit 52 may be connected to one end of the coil 22, while the electrical conduit 54 may be connected to the other end of the coil 22.

The electrical current may then be provided to a rectifier 55, which converts the current received from the coil 22 from AC to DC. The DC can then be used to charge a battery 58 or another type of energy storage device. A regulator 56 can also be used to control the flow of current to and from the battery 58. The energy storage device 50 can also include a switch 59 to electrically separate the battery 58 from the rectifier 55. The battery 58 can be connected to an electrical load 60. The electrical load 60 can be any type of electrical load and may be in the form of an electrical device.

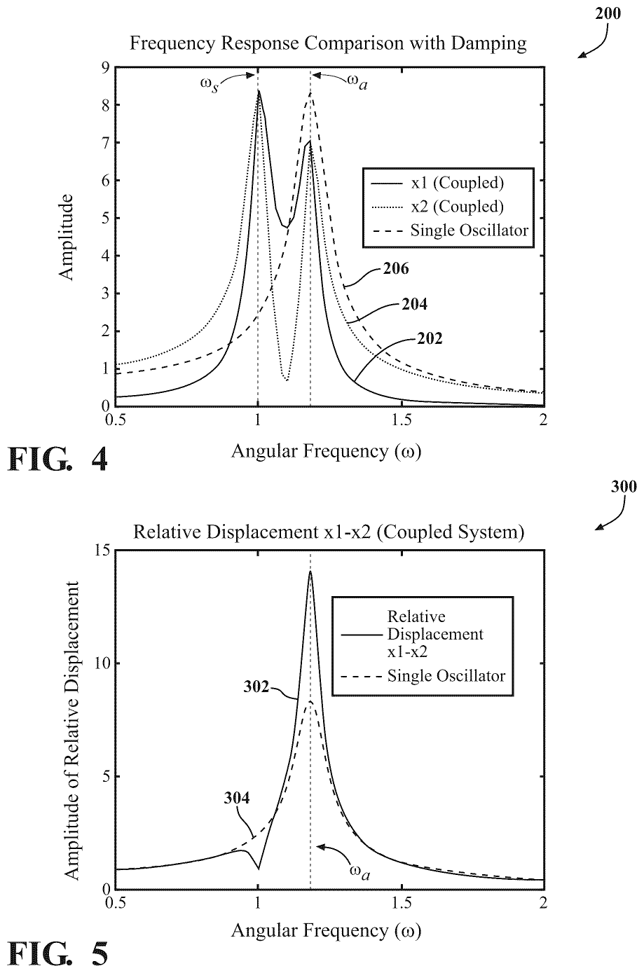

As to the performance of the vibration energy harvesting system 10 (modeled as the model 100 in FIG. 2), reference is made to FIGS. 4 and 5. Moreover, FIG. 4 shows a chart 200 illustrating the spectra 202 and 204 of the vibration energy harvesting system 10. Moreover, illustrated are a first resonance peak (ωₛ) and a second resonance peak (ωₐ) of the spectra 202 and 204 of the relative displacements (x₁ and x₂) of the mass 120 and the mass 130, respectively. In addition, for the sake of comparison, also illustrated is the spectra 206 of a prior art system, which does not take advantage of coupled resonance.

As mentioned, the spectra 202 and 204 show the two resonance peaks of the vibration energy harvesting system 10 due to the coupling between the structures 20 and 30. The first resonance peak (ωₛ) corresponds to the symmetric mode, wherein the vibration motions of the coil 22 and magnet 32 are in phase, which can be expressed as ωs=\sqrt{k/m}(here, k=k₁=k₂) . The second resonance peak (ωₐ) represents the asymmetric mode (the vibration motions of the coil 22 and magnet 32 are out-of-phase). For energy harvesting, the out-of-phase vibration motions of magnet 32 and coil 22 are effective for energy harvesting. The resonance frequency of the resonance peak may be expressed as ωₐ=\sqrt{(k+2k_{c})/m}. As an example, k_{c}=0.2 N/m, b₂=0.1\sqrt{k/m}, b₂=0.2b₁, and m=m₁=m₂=1 kg, k=1 N/m.

FIG. 5 illustrates a chart 300 of the relative displacement 302 (x₁ and x₂) of the mass 120 and the mass 130 of the vibration energy harvesting system 10. In the relative displacement, the resonance peak (ωₛ) for in-phase motion disappears, whereas the second peak (ωₐ) remains high. Also, for the sake of comparison, shown is the relative displacement 304 of the prior art system that does not take advantage of coupled resonance. The coupled resonator exhibits better performance compared to the prior art single resonator-based harvester.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

The terms “substantially similar,” “substantially equal,” and the like, when used to compare one or more physical properties, may indicate a variance of up to 20% unless otherwise specified.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, indicating the scope hereof.

What is claimed is:

1. A system comprising:
a first structure having a coil;
a second structure having a magnet; and
a coupling structure connecting the first structure to the second structure.

2. The system of claim 1, wherein the magnet and the coil are positioned such that when the coil and the magnet move with respect to each other, a voltage is produced at the coil.

3. The system of claim 1, wherein:
the first structure is a first cantilever; and
the second structure is a second cantilever.

4. The system of claim 3, wherein the coil is attached to a distal end of the first cantilever.

5. The system of claim 3, wherein the magnet is attached to a distal end of the second cantilever.

6. The system of claim 3, wherein lengths the first cantilever and the second cantilever substantially similar.

7. The system of claim 1, further comprising an energy storage device connected to the coil and configured to store electrical energy generated by the coil when the coil and the magnet move with respect to each other.

8. The system of claim 1, wherein the system is a vibration energy harvesting system.

9. The system of claim 1, wherein the coupling structure is made of a flexible material.

10. The system of claim 1, wherein a stiffnesses of the first structure and the second structure are substantially similar.

11. The system of claim 10, wherein a stiffness of the coupling structure is less than that of the first structure and the second structure.

12. A vibration energy harvesting system comprising:
a first cantilever extending from a surface and terminating with a distal end, wherein a coil is coupled to the distal end of the first cantilever;
a second cantilever extending from the surface and terminating with a distal end, wherein a magnet is coupled to the distal end of the second cantilever;
a coupling structure connecting the first cantilever to the second cantilever; and
the magnet and coil are positioned such that when the coil and magnet move with respect to each other, a voltage is produced at the coil.

13. The vibration energy harvesting system of claim 12, wherein lengths of the first cantilever and the second cantilever are substantially similar.

14. The vibration energy harvesting system of claim 12, further comprising an energy storage device connected to the coil and configured to store electrical energy generated by the coil when the coil and the magnet move with respect to each other.

15. The vibration energy harvesting system of claim 12, wherein the coupling structure is made of a flexible material.

16. The vibration energy harvesting system of claim 12, wherein a stiffnesses of the first cantilever and the second cantilever are substantially similar.

17. The vibration energy harvesting system of claim 16, wherein a stiffness of the coupling structure is less than that of the first cantilever and the second cantilever.

18. The vibration energy harvesting system of claim 12, wherein the first cantilever and the second cantilever extend from the surface in directions that are substantially parallel to each other.

19. A system comprising:
a first cantilever having a coil;
a second cantilever having a magnet;
a coupling structure connecting the first cantilever to the second cantilever; and
the magnet and the coil are positioned such that when the coil and magnet move with respect to each other, a voltage is produced at the coil.

20. The system of claim 19, further comprising an energy storage device connected to the coil and configured to store electrical energy generated by the coil when the coil and the magnet move with respect to each other.
